(19) United States
(12) Patent Application Publication
(10) Pub. No.: US 2019/0184638 A1
(43) Pub. Date: Jun. 20, 2019

(54) THREE-DIMENSIONAL OBJECT SHAPING METHOD AND APPARATUS

(71) Applicants: MIMAKI ENGINEERING CO., LTD., Nagano (JP); GRAPHIC CREATION Co., Ltd., Nagano (JP)

(72) Inventors: Kunio Hakkaku, Nagano (JP); Katsuyuki Kurihara, Nagano (JP); Hirofumi Hara, Nagano (JP)

(73) Assignees: MIMAKI ENGINEERING CO., LTD., Nagano (JP); GRAPHIC CREATION Co., Ltd., Nagano (JP)

(21) Appl. No.: 16/221,621

(22) Filed: Dec. 17, 2018

(30) Foreign Application Priority Data
Dec. 18, 2017 (JP) 2017-242153
Aug. 8, 2018 (JP) 2018-149658

(51) Int. Cl. B29C 64/245; B29C 64/135; B29C 64/112

(52) U.S. Cl. CPC B29C 64/245; B33Y 10/00; B29C 64/112; B29C 64/135

(57) ABSTRACT

A three-dimensional object shaping method and apparatus are provided that suppress a risk of a three-dimensional object being deformed. In the three-dimensional object shaping method, a three-dimensional object is formed on a working plane. This method includes a three-dimensional object shaping step and a deformation restrainer shaping step. In the deformation restrainer shaping step, a deformation restrainer is formed simultaneously with the three-dimensional object shaping step in contact in at least a part of the deformation restrainer with the three-dimensional object. The deformation restrainer is a portion distinct from a target portion of the three-dimensional object formed in the three-dimensional object shaping step and serving to generate a force that acts against stress causing the target portion to deform.

### CROSS REFERENCE TO RELATED APPLICATIONS

This application claims the priority benefit of Japanese Patent Application No. 2018-149658, filed on Aug. 8, 2018, and Japanese Patent Application No. 2017-242153, filed on Dec. 18, 2017. The entirety of each of the above-mentioned patent applications is hereby incorporated by reference herein and made a part of this specification.

### TECHNICAL FIELD

This disclosure relates to a method and an apparatus for shaping a three-dimensional object.

### DESCRIPTION OF THE BACKGROUND ART

There are known three-dimensional object shaping apparatuses that have been developed to obtain three-dimensional objects (For example, JP 2016-7711 A). In a three-dimensional object shaping method using such a three-dimensional object shaping apparatus, a modeling material used to form the three-dimensional object and a support material that serves to support the modeling material are ejected from a head to a working plane and stacked in layers. Then, the support material is later removed to complete shaping of a three-dimensional object. Other known methods may be employed, for example, a method for shaping a three-dimensional object by sintering particles of a powdery material made of, for example, a metal under laser light, or a method for shaping a three-dimensional object by binding particles of a powdery material made of, for example, a resin using a binder.

### SUMMARY

In the three-dimensional object shaping methods described earlier, the modeling material may be layered in a flat shape to form a block-shaped object or an object with a flat portion like a top plate of a table, or the modeling material may be layered in a linear shape or a bar-like shape for certain shapes of the three-dimensional object to be obtained. Then, the modeling material may be partly deformed under stress. Such deformation of the modeling material may cause the three-dimensional object to degrade in quality or cause the three-dimensional object to be poorly shaped in case any deformed part contacts the head during an object-shaping operation.

What is disclosed herein was accomplished to address the issues of the known art. A method and an apparatus for shaping a three-dimensional object are provided that suppress a risk of a three-dimensional object being deformed.

This disclosure provides a method for shaping a three-dimensional object on a working plane, including: a three-dimensional object shaping step of stacking a modeling material and a support material in layers on the working plane, the modeling material constituting the three-dimensional object, the support material serving to support the modeling material; and a deformation restrainer shaping step of forming a deformation restrainer away from the working plane and in contact in at least a part thereof with the support material, the deformation restrainer being a portion distinct from a target portion formed of the modeling material in the three-dimensional object shaping step and serving to generate a force that acts against stress causing the target portion to deform.

According to the method thus configured, the deformation restrainer may serve to generate a force that acts against stress-driven deformation, if any, of the target portion formed of the modeling material. This may suppress the risk of the target portion being deformed. Because the deformation restrainer at least partly stays in contact with the support material, the contact with the support material may ensure that a force is generated against possible deformation of the target portion. Further, the deformation restrainer formed in contact with the three-dimensional object may suppress the risk of the target portion being deformed regardless of any shape of the three-dimensional object.

In the three-dimensional object shaping method, the deformation restrainer shaping step may form a connector that allows the deformation restrainer to connect in at least a thinned part thereof to the target portion.

This may allow the deformation restrainer to receive, through the connector, stress causing the target portion to deform and thus further ensures that a force is generated against such deformation-causing stress.

In the three-dimensional object shaping method, the deformation restrainer shaping step may form a base of the deformation restrainer on a side opposite to the target portion across the connector, so that the connector is tapered and thinner toward the target portion.

According to this configuration, the connector has a part progressively thinner toward the target portion. After the object is completed, therefore, the thinned part may facilitate removal of the deformation restrainer that is no longer necessary.

In the three-dimensional object shaping method, the deformation restrainer shaping step may form the base so as to have a shorter dimension in a planar direction in which ends of the base formed on the support material possibly detach and warp away from the support material.

According to this configuration, any possible warp of the end of the base from the support material may be prevented by forming the base to be shorter in a dimension in the planar direction in which the end of the base possibly warp and detach from the support material.

The three-dimensional object shaping method may further include a removing step of removing the deformation restrainer connected to the target portion from the three-dimensional object after the three-dimensional object is formed of the modeling material and the support material is removed.

According to this configuration, the three-dimensional object may be readily obtained by removing the deformation restrainer after the support material is removed from the object.

In the three-dimensional object shaping method, the deformation restrainer shaping step may form the deformation restrainer in a shape having a portion formed along a direction intersecting with the working plane.

According to this configuration, such a part formed in the deformation restrainer along a direction intersecting with the working plane may prevent the deformation restrainer from extending along the working plane. As a result, the support material used may be economized.

In the three-dimensional object shaping method, the deformation restrainer shaping step may form the deformation restrainer in a shape having a flat portion parallel to the working plane.

According to this configuration, the flat portion may enhance the contact with the support material and thereby ensure that a force is generated against possible deformation of the target portion.

In the three-dimensional object shaping method, the deformation restrainer shaping step may form at least two deformation restrainers in a direction intersecting with the working plane. One of the two deformation restrainers closer to the working plane may have a shape with a flat portion parallel to the working plane, while the other one of the two deformation restrainers farther from the working plane may have a shape with a portion formed along a direction intersecting with the working plane.

By providing at least two deformation restrainers, the deformation restrainers may be prevented from extending along the working plane, and a force may be surely generated against possible deformation of the target portion.

In the three-dimensional object shaping method, the deformation restrainer shaping step may form the deformation restrainer using the modeling material.

Using the modeling material to form the deformation restrainer may save additional labor of preparing a dedicated material for the deformation restrainer.

In the three-dimensional object shaping method, the deformation restrainer may have a higher degree of hardness than layers of the support material.

According to this configuration, the deformation restrainer thus harder than layers of the support material may serve to prevent unwanted penetration when deformation of the target portion occurs.

In the three-dimensional object shaping method, the target portion may have a higher degree of hardness than layers of the support material.

While the target portion, if deformed, is possibly detached from the support material, the target portion formed of the modeling material harder than the support material may be unlikely to detach from the support material.

This disclosure further provides a method for shaping a three-dimensional object on a working plane, including: a three-dimensional object shaping step of stacking a powdery material in layers on the working plane and repeatedly irradiating the layers with laser light appropriate for shape-related data to form the three-dimensional object; and a deformation restrainer shaping step of forming, simultaneously with the formation of the three-dimensional object, a deformation restrainer in contact in at least a part thereof with the three-dimensional object, the deformation restrainer being a portion distinct from a target portion of the three-dimensional object formed in the three-dimensional object shaping step and serving to generate a force that acts against stress causing the target portion to deform.

According to the method thus configured, the deformation restrainer may serve to generate a force that acts against stress-driven deformation, if any, of the target portion when the three-dimensional object is obtained by stacking a powdery material in layers on the working plane and repeatedly irradiating the layers with laser light appropriate for shape-related data. This may suppress the risk of the target portion being deformed.

This disclosure further provides a method for shaping a three-dimensional object on a working plane, including: a three-dimensional object shaping step of stacking a powdery material in layers on the working plane and ejecting a binder material appropriate for shape-related data to the powdery material to form the three-dimensional object; and a deformation restrainer shaping step of forming, simultaneously with the formation of the three-dimensional object, a deformation restrainer in contact in at least a part thereof with the three-dimensional object, the deformation restrainer being a portion distinct from a target portion of the three-dimensional object formed in the three-dimensional object shaping step and serving to generate a force that acts against stress causing the target portion to deform.

According to the method thus configured, the deformation restrainer may serve to generate a force that acts against stress-driven deformation, if any, of the target portion when the three-dimensional object is obtained by stacking a powdery material in layers on the working plane and ejecting a binder material appropriate for shape-related data to the powdery material. This may suppress the risk of the target portion being deformed.

This disclosure further provides a method for shaping a three-dimensional object on a working plane, including: a three-dimensional object shaping step of stacking a modeling material and a support material in layers on the working plane, the modeling material constituting the three-dimensional object, the support material serving to support the modeling material; and a deformation restrainer shaping step of forming a deformation restrainer in contact in at least a part thereof with the working plane and in contact in at least a part thereof with the support material, the deformation restrainer being a portion distinct from a target portion formed of the modeling material in the three-dimensional object shaping step and serving to generate a force that acts against stress causing the target portion to deform.

According to this configuration, the deformation restrainer in contact in at least a part thereof with the working plane may more effectively generate a force that acts against the deformation-causing stress.

This disclosure further provides a three-dimensional object shaping apparatus configured to shape a three-dimensional object on a working plane, including: an inkjet ejection unit that ejects a modeling material, a support material, and a deformation restrainer material to the working plane, the modeling material constituting the three-dimensional object, the support material serving to support the modeling material, the deformation restrainer material forming a deformation restrainer, the deformation restrainer being a portion distinct from a target portion formed of the modeling material and serving to generate a force that acts against stress causing the target portion to deform; and a controller that prompts the inkjet ejection unit to form the deformation restrainer away from the working plane and in contact in at least a part thereof with the support material at a time of the target portion being formed.

According to the method thus configured, the deformation restrainer may serve to generate a force that acts against stress-driven deformation, if any, of the target portion formed of the modeling material. This may suppress the risk of the target portion being deformed. Because the deformation restrainer at least partly stays in contact with the support material, the contact with the support material may ensure that a force is generated against any deformation of the target portion in three-dimensional directions. Further, the deformation restrainer formed in contact with the three-dimensional object may suppress the risk of the target portion being deformed regardless of any shape of the three-dimensional object. The risk of the target portion being deformed may be accordingly reduced, and the object-shaping operation may be smoothly performed.

This disclosure further provides a three-dimensional object shaping apparatus configured to shape a three-dimensional object on a working plane, including an object shaping unit that stacks a powdery material in layers on the working plane and repeatedly irradiating the layers with laser light appropriate for shape-related data to form the three-dimensional object and a deformation restrainer, the deformation restrainer being a portion distinct from a target portion of the three-dimensional object and serving to generate a force that acts against stress causing the target portion to deform; and a controller that prompts the object-shaping unit to form, simultaneously with the formation of the three-dimensional object, the deformation restrainer in contact in at least a part thereof with the three-dimensional object at a time of the target portion being formed.

According to the apparatus thus configured to form the three-dimensional object by stacking a powdery material in layers on the working plane and repeatedly irradiating the layers with laser light appropriate for shape-related data, the risk of the target portion being deformed may be effectively reduced, which may allow the object-shaping operation to be smoothly carried out.

This disclosure further provides a three-dimensional object shaping apparatus configured to shape a three-dimensional object on a working plane, including an object shaping unit that stacks a powdery material in layers on the working plane and ejecting a binder material appropriate for shape-related data to the powdery material to form the three-dimensional object and a deformation restrainer, the deformation restrainer being a portion distinct from a target portion of the three-dimensional object and serving to generate a force that acts against stress causing the target portion to deform; and a controller that prompts the object-shaping unit to form, simultaneously with the formation of the three-dimensional object, the deformation restrainer in contact in at least a part thereof with the three-dimensional object at a time of the target portion being formed.

According to the apparatus thus configured to form the three-dimensional object by stacking a powdery material in layers on the working plane and ejecting a binder material appropriate for the shape-related data to the powdery material, the risk of the target portion being deformed may be effectively reduced, and the object-shaping operation may be smoothly performed.

This disclosure provides a three-dimensional object shaping method and apparatus that may successfully suppress the risk of a three-dimensional object being deformed.

### BRIEF DESCRIPTION OF THE DRAWINGS

FIG. 1 is a schematic drawing of a three-dimensional object shaping apparatus according to an embodiment of this disclosure.

FIG. 2 is a drawing of a surface side of an ejection unit from which ink droplets are ejected.

FIG. 3 is a drawing of a three-dimensional object formed on a working plane by the ejection unit and a deformation restrainer.

FIG. 4 is another drawing of the three-dimensional object formed on the working plane by the ejection unit and the deformation restrainer.

FIG. 5 is an enlarged view of a portion encircled with a broken line in FIG. 4.

FIG. 6 is a functional block diagram of a controller.

FIG. 7 is a flow chart of an operation carried out by the three-dimensional object shaping apparatus.

FIG. 8 is a drawing that illustrates a stage in the operation carried out by the three-dimensional object shaping apparatus.

FIG. 9 is a drawing that illustrates a stage in the operation carried out by the three-dimensional object shaping apparatus.

FIG. 10 is a drawing that illustrates a stage in the operation carried out by the three-dimensional object shaping apparatus.

FIG. 11 is a drawing of an exemplified deformation of the three-dimensional object.

FIG. 12 is a drawing of a modified example of the three-dimensional object formed on the working plane and the deformation restrainer.

FIG. 13 is a drawing of a modified example of the three-dimensional object formed on the working plane and the deformation restrainer.

FIG. 14 is a drawing of a modified example of the three-dimensional object formed on the working plane and the deformation restrainer.

FIG. 15 is a drawing that illustrates an example of the deformation restrainer.

FIG. 16 is a drawing that illustrates an example of the deformation restrainer.

FIG. 17 is a drawing that illustrates an example of the deformation restrainer.

FIG. 18 is a drawing that illustrates an example of the deformation restrainer.

FIG. 19 is a drawing that illustrates an example of the deformation restrainer.

FIG. 20 is a drawing that illustrates an example of the deformation restrainer.

FIG. 21 is a drawing of a three-dimensional object shaping method.

FIG. 22 is a drawing of another three-dimensional object shaping method.

FIG. 23 is a drawing of yet another three-dimensional object shaping method.

### DETAILED DESCRIPTION OF EMBODIMENTS

Embodiments of a three-dimensional object shaping method and apparatus disclosed herein are hereinafter described in detail referring to the accompanying drawings. This disclosure includes but is not limited to the embodiments hereinafter described. Structural means and technical aspects in the embodiments described below may include ones that are replaceable and easily anticipated by those skilled in the art or substantially identical.

### Embodiments

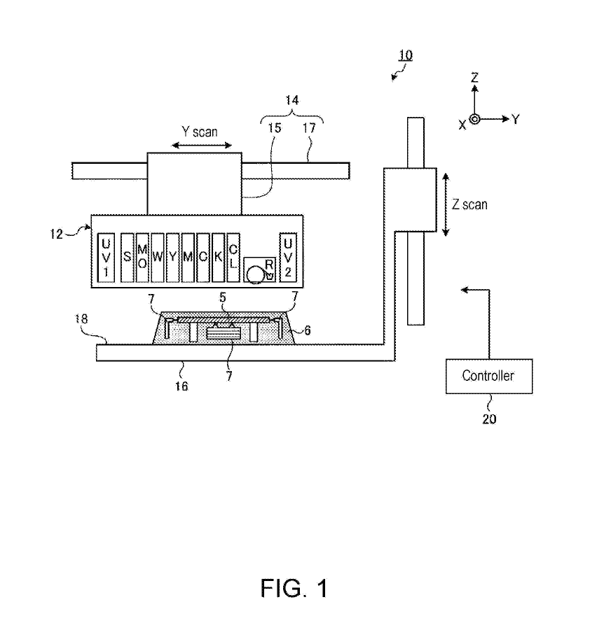

FIG. 1 is a schematic drawing of a three-dimensional object shaping apparatus according to an embodiment of this disclosure. A three-dimensional object shaping apparatus 10 illustrated in FIG. 1 is configured to shape a three-dimensional object 5 by multilayer lamination technique. The multilayer lamination technique may refer to a method for shaping the three-dimensional object 5 by forming a plurality of layers on one another. Examples of the three-dimensional object 5 may include various structures three-dimensionally formed. The three-dimensional object shaping method carried out by the three-dimensional object shaping apparatus 10 are applicable to a method for shaping a three-dimensional object by sintering particles of a powdery material made of, for example, a metal under laser light, or a method for shaping a three-dimensional object by binding particles of a powdery material made of, for example, a resin using a binder. In such other methods, a deformation restrainer(s) may be formed in a similar manner to the three-dimensional object 5, and a support material may be a powdery material used to form any part but the object per se. While powdery materials may fail to provide enough strength to support the three-dimensional object 5 currently shaped and the deformation restrainer, a certain kind of liquid may be used to bind particles of the powdery material in a portion that supports the object currently shaped. The liquid may be a water-soluble liquid, in which case the liquid is removed with particles of the powdery material by immersing the object in water, and the three-dimensional object 5 with the deformation restrainer connected thereto is retrieved from the water. Then, the deformation restrainer is detached from the three-dimensional object 5, so that the three-dimensional object 5 is obtained as a final product.

Except for the aspects hereinafter described, the three-dimensional object shaping apparatus 10 may be configured similarly or identically to the known three-dimensional object shaping apparatuses. The three-dimensional object shaping apparatus 10 may be a partly reconfigured known inkjet printer for two-dimensional printing. For example, a known inkjet printer that uses ultraviolet-curable ink (UV ink) may be partly reconfigured and used as the three-dimensional object shaping apparatus 10.

The three-dimensional object shaping apparatus 10 according to this embodiment includes an ejection unit 12, a main scan driver 14, an object-shaping table 16 on which the three-dimensional object 5 is formable, and a controller 20. The ejection unit 12 ejects droplets of a material used to form the three-dimensional object 5. The ejection unit 12 ejects, for example, droplets of a curable resin that is cured under certain conditions, and then cures the droplets to form layers constituting the three-dimensional object 5. Specifically, the ejection unit 12 repeatedly carries out two operations multiple times; an operation to eject droplets of the curable resin as prompted by the controller 20 to form a layer, and an operation to cure the layer of the curable resin. The ejection unit 12 repeatedly carries out these operations to form a plurality of layers of the cured resin on one another.

The curable resin ejected from the ejection unit 12 may be an ultraviolet-curable resin that is cured under ultraviolet irradiation. In this instance, the droplets of the material ejected from the ejection unit 12 to form the three-dimensional object 5 are droplets of the ultraviolet-curable ink. The layers of the curable resin are irradiated with ultraviolet light emitted from a light source and thereby cured. The layers of the curable resin in this instance are layers of the ultraviolet-curable ink.

In the three-dimensional object shaping apparatus 10 according to this embodiment, the ejection unit 12 ejects ink prepared to form the three-dimensional object 5 to a working plane 18 on an upper surface of the object-shaping table 16. The ejection unit 12 ejects droplets of ultraviolet-curable color ink to color an outer surface or an interior of the three-dimensional object 5 and obtain a colored three-dimensional object 5. The ejection unit 12 also forms a support 6 around the three-dimensional object 5 during an operation to shape this object. The support 6 is a layered structure (support layers) that supports the three-dimensional object 5 currently shaped and is dissolved in water or the like and removed from the completed three-dimensional object 5.

In this embodiment, the ejection unit 12 further forms a deformation restrainer 7. When a modeling material is ejected and stacked in layers in the operation to shape the three-dimensional object 5, stress may be generated, which possibly deforms the layered modeling material. During the operation to form the three-dimensional object 5, the deformation restrainer 7 generates a force that acts against such stress-driven deformation, if any, of a deformable target portion formed of the modeling material (for example, top plate 52 described later). In this embodiment, the ejection unit 12 forms the deformation restrainer 7 using ink similar to ink containing the modeling material used to form the three-dimensional object 5. The ejection unit 12 may form the deformation restrainer 7 using, apart from the modeling material, ink containing a material prepared to control possible deformation. In this instance, the apparatus may be further equipped with a head for ejection of the deformation restrainer material. Specific structural features and operation of the ejection unit 12 (including the formation of the deformation restrainer 7) will be described later in further detail.

The main scan driver 14 drives the ejection unit 12 to perform main scans. The main scan driver 14, by thus driving the ejection unit 12 to perform main scans, functions as a relative movement driver that moves the ejection unit 12 and the working plane 18 relative to each other. When the ejection unit 12 is prompted to perform main scans in this embodiment, it may be inkjet heads of the ejection unit 12 that actually perform main scans. The main scan may be an operation in which the ejection unit 12 ejects the ink droplets while moving in a predetermined main scanning direction (Y direction in the drawing).

The main scan driver 14 has a carriage 15 and a guide rail 17. The carriage 15 is a holder that holds the ejection unit 12 so as to face the working plane 18 of the object-shaping table 16. The carriage 15 holds the ejection unit 12 so that the ink droplets ejected from the ejection unit 12 are directed toward the working plane 18. In each main scan, the carriage 15 holding the ejection unit 12 moves along the guide rail 17. The guide rail 17 is a member that guides movement of the carriage 15. In each main scan, the guide rail 17 moves the carriage 15 as prompted by the controller 20.

A movement of the ejection unit 12 in each main scan may be a relative movement to the three-dimensional object 5. In a modified example of the three-dimensional object shaping apparatus 10, therefore, the three-dimensional object 5 may be moved by moving the object-shaping table 16, with the ejection unit 12 remaining unmoved at a position.

The object-shaping table 16 has, on its upper surface, the working plane 18, on which the three-dimensional object 5 is shaped. The object-shaping table 16 is equipped to move its upper surface upward and downward (Z direction in the drawing), and moves the upper surface, as prompted by the controller 20, so as to follow the progress of the three-dimensional object 5 currently shaped. Thus, a distance (interval) between the ejection unit 12 and a target surface of the three-dimensional object 5 currently shaped may be suitably adjusted. The target surface of the three-dimensional object 5 currently shaped is a surface on which a next layer is formed by the ejection unit 12. In each main scan, the ejection unit 12 may be moved upward and downward in the Z direction, instead of the object-shaping table 16 being moved in the Z direction relative to the ejection unit 12.

The three-dimensional object shaping apparatus 10 may further include any other means required to color and/or shape the three-dimensional object 5. For example, the three-dimensional object shaping apparatus 10 may have a sub scan driver that drives the ejection unit 12 to perform sub scans. The sub scan may be an operation in which inkjet heads of the ejection unit 12 move in a sub scanning direction (X direction in the drawing) orthogonal to the main scanning direction relative to the three-dimensional object 5 currently shaped. In this instance, the sub scan driver may be a relative movement driver configured to move the ejection unit 12 and the working plane 18 relative to each other in the sub scanning direction. The sub scan driver, i.e., relative movement driver, may drive the ejection unit 12 to perform sub scans, as required, in case the three-dimensional object 5 is formed in a length in the sub scanning direction greater than an object-shaping width of the inkjet heads of the ejection unit 12. Specifically, the sub scan driver may drive the object-shaping table 16 to move in the sub scanning direction or may drive the guide rail 17 and the carriage 15 holding the ejection unit 12 to move in the sub scanning direction, insofar as this relative movement driver is allowed to move one of the ejection unit 12 and the working plane 18 relative to the other in at least one of the main scanning direction and the sub scanning direction.

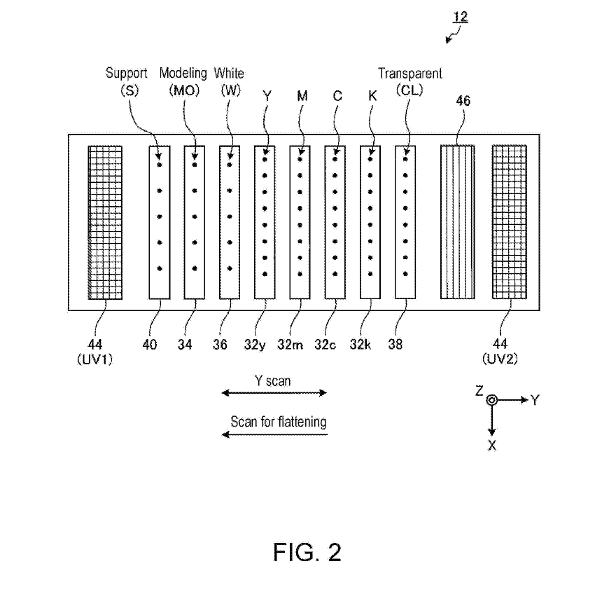

FIG. 2 is a drawing of a surface side of the ejection unit 12 from which the ink droplets are ejected. The ejection unit 12 has a plurality of color ink heads 32y, 32m, 32c, and 32k (hereinafter, color ink heads 32y-k), a white ink head 36, a clear ink head 38, a modeling material head 34, a support material head 40, a plurality of ultraviolet light sources 44, and a flattening roller unit 46.

The color ink heads 32y-k, white ink head 36, clear ink head 38, and modeling material head 34 are inkjet heads that eject the curable resin-containing droplets. The color ink heads 32y-k, white ink head 36, clear ink head 38, and modeling material head 34 eject droplets of ultraviolet-curable inks and are arranged in the main scanning direction (Y direction) in positional alignment with one another in the sub scanning direction (X direction).

The color ink heads 32y-k eject droplets of color inks of different colors used as colorants. The color ink heads 32y-k are allowed to eject droplets of ultraviolet-curable color inks of yellow (Y), magenta (M), cyan (C), and black (K) used in the subtractive color mixture. The white ink head 36 ejects droplets of a white (W) ultraviolet-curable ink. Such different color inks constitute the colorants.

The clear ink head 38 ejects droplets of a clear-colored ultraviolet-curable ink (clear ink). The clear ink is a transparent (CL), colorless ink. The clear ink is a colorant-less ink containing an ultraviolet-curable resin.

The modeling material head 34 ejects droplets of an ultraviolet-curable ink used as the modeling material to shape the three-dimensional object 5. The modeling material head 34 is allowed to eject droplets of a modeling ink (MO) having a predetermined color. While examples of the modeling ink may include the white ink and the transparent clear ink, an optional color ink may be used unless the three-dimensional object 5 is required to have an outer surface in full color.

The support material head 40 is an inkjet head that ejects droplets of a support material (S) used to form the support 6 (see FIG. 1). The material of the support 6 may suitably be a water-soluble material that can be dissolved in water after the three-dimensional object 5 is completed. The material of the support 6 may be selected from the known materials usable to form such a support. The support material may be selected from materials by which the support 6 has a lower degree of hardness than a portion formed of the modeling material. The portion formed of the modeling material accordingly has a higher degree of hardness than a portion formed of the support material (support 6).

The color ink heads 32y-k, white ink head 36, clear ink head 38, modeling material head 34, and support material head 40 may be suitably selected from the known inkjet heads. These inkjet heads each have, on its surface facing the working plane 18 of the object-shaping table 16 (see FIG. 1), a nozzle array having nozzles aligned in the sub scanning direction. The nozzle arrays of the inkjet heads are aligned in the same direction and are arranged in parallel to one another. In the main scans, these inkjet heads, while moving in the main scanning direction orthogonal to the nozzle-aligned direction, eject the ink droplets in the Z direction.

The ultraviolet light sources 44 radiate ultraviolet light to cure the ultraviolet-curable inks, examples of which may include ultraviolet LED (Light Emitting Diode), metal halide lamps, and mercury lamps. The ultraviolet light sources 44 are respectively disposed on one end side and the other end side of the ejection unit 12 in the main scanning direction across the color ink heads 32y-k, white ink head 36, clear ink head 38, modeling material head 34, and support material head 40. In the three-dimensional object shaping apparatus 10 according to this embodiment, UV1 and UV2 are used as the ultraviolet light sources 44. The UV1 is disposed on one end side of the ejection unit 12 in the main scanning direction (Y direction), while UV2 is disposed on the other end side of the ejection unit 12 in the main scanning direction (Y direction).

The flattening roller unit 46 is a means provided to flatten layers of the ultraviolet-curable inks formed during the operation to shape the three-dimensional object 5. The flattening roller unit 46 is disposed between the UV2 (ultraviolet light source 44 on the other end side of the ejection unit 12) and the group of the color ink heads 32y-k, white ink head 36, clear ink head 38, modeling material head 34, and support material head 40. The flattening roller unit 46 is disposed in the main scanning direction next to the group of the color ink heads 32y-k, white ink head 36, clear ink head 38, modeling material head 34, and support material head 40, with positions of the flattening roller unit 46 and these inkjet heads being aligned with one another in the sub scanning direction. The flattening roller unit 46 is disposed in the ejection unit 12 so as to move upward and downward relative to the ejection unit 12.

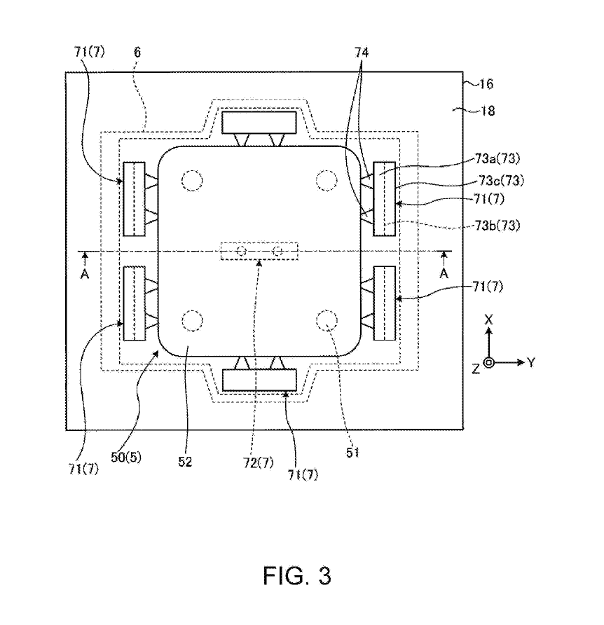

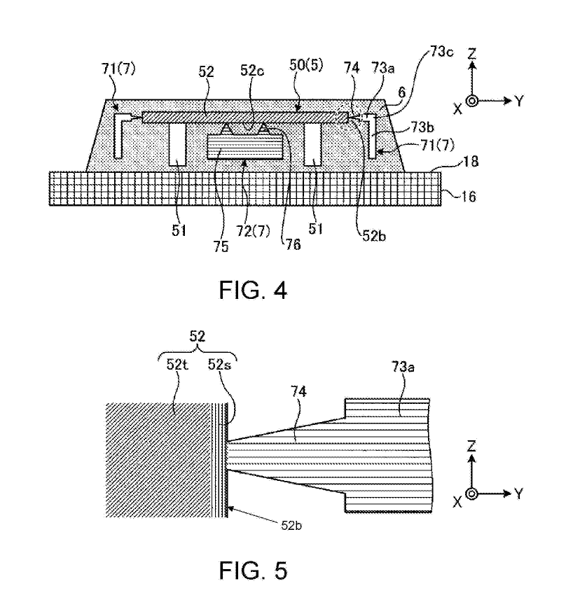

FIGS. 3 and 4 are drawing of the three-dimensional object 5 formed on the working plane 18 by the ejection unit 12 and the deformation restrainer 7. FIG. 3 is a plan view, and FIG. 4 is an A-A cross-sectional view of FIG. 3. FIG. 5 is an enlarged view of a portion encircled with a broken line in FIG. 4. This embodiment is hereinafter described referring to an example in which the three-dimensional object 5 to be shaped is a model of a table 50 with four legs.

The table 50 has legs 51 and a top plate 52. The legs 51 support the top plate 52. The top plate 52 has a rectangular flat shape. The table 50 is formed, with the legs 51 and the top plate 52 being supported by the support 6. In this embodiment, the top plate 52 is a target portion supported by the support 6.

The deformation restrainer 7 includes side restrainers 71 and a bottom restrainer 72. The side restrainers 71 each have a base 73 and connectors 74. The bases 73 are situated on lateral sides of the top plate 52. The base 73 has a first piece 73a formed along the working plane 18, and a second piece 73b formed so as to intersect with the working plane 18. The first piece 73a and the second piece 73b are bent at a bending part 73c and are connected to each other. In this embodiment, the first piece 73a is parallel to the working plane 18, while the second piece 73b is perpendicular to the working plane 18. The second piece 73b has a part formed along a direction intersecting with the working plane 18 and held by the support 6. The second piece 73b is, therefore, restricted in upward and downward (Z direction) movements in FIG. 4. This structural feature may prevent that side surfaces of the top plate 52 receive impact through the connectors 74 and thereby deform upward or downward (Z direction) in FIG. 4.

The connector 74 is extending from an end of the first piece 73a toward a side surface 52b of the top plate 52 and is connected to the side surface 52b. While the shown connectors 74 are tapered and thinner toward the side surface 52b, there are other optional shapes of the connectors 74 described later, instead of the tapered shape. When the top plate 52 is, for example, 3 mm in thickness, a part of the connector 74 in contact with the side surface 52b may desirably have a width of 0.5 mm to 2 mm in cross section. However, the width may be selected from suitable values in view of factors including; number of connectors 74, magnitude of stress causing the top plate 52 to deform, and easiness to break the top plate off at the connector 74 to detach the deformation restrainer 7 after the operation is over. As illustrated in FIG. 5, the top plate 52 has an inner portion 52t formed of, for example, white ink, and a surface portion 52s formed of colored inks or clear ink. The connector 74 may be formed of the same ink as used in the surface portion 52s of the top plate 52, in which case the connector 74 may have the same color as the surface portion of the top plate 52. The connector 74 may be formed of ink that differs from the ink used to form the surface portion 52s. For example, the color inks may be used to form the surface portion 52s, and the clear ink may be used to form the connector 74, in which case the surface portion of the top plate 52 may be less affected in color after the connector 74 is broken off.

The bottom restrainer 72 has a base 75 and connectors 76. The base 75 is situated at a position closer to the working plane 18 than the top plate 52. The connectors 76 are protruding from a part of the base 75 facing a bottom surface 52c toward the bottom surface 52c. While the shown connectors 76 may be tapered and thinner toward the bottom surface 52c, the connectors 76 may be shaped otherwise. The connector 76 may be formed of the same ink as used in the surface portion 52s of the top plate 52. The connector 76 may be formed of any ink but the ink used to form the surface portion 52s.

The controller 20 controls the structural elements of the three-dimensional object shaping apparatus 10, for example, controls the operations of the ejection unit 12 and the main scan driver 14. The controller 20 has a CPU (Central Processing Unit) for executing various processes, RAM (Random Access Memory) as a storage for various pieces of information, and ROM (Read Only Memory). The controller 20 controls the structural elements of the three-dimensional object shaping apparatus 10 to form the three-dimensional object 5 desirably obtained based on shape-related information and color image-related information of the three-dimensional object 5.

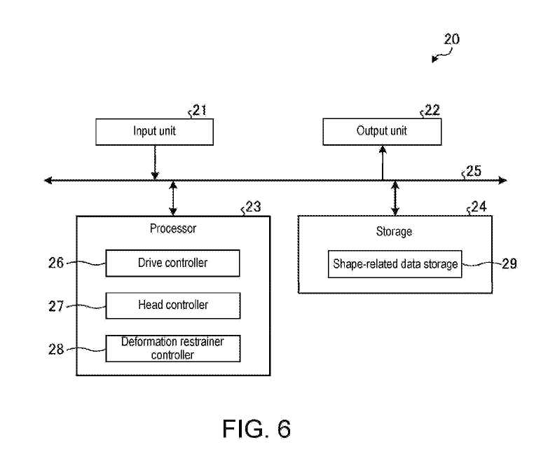

FIG. 6 is a functional block diagram of the controller 20. As illustrated in FIG. 6, the controller 20 includes an input unit 21, an output unit 22, a processor 23, a storage 24, and a bus line 25 that interconnects these devices. The input unit 21 receives data inputted from an external apparatus such as a personal computer, not illustrated in the drawing. The output unit 22 outputs control signals operable to control of an object-shaping operation.

The processor 23 has a drive controller 26, a head controller 27, and a deformation restrainer controller 28. The drive controller 26 controls movements of the ejection unit 12 and the object-shaping table 16. The head controller 27 controls the operation to eject inks from the color ink heads 32y to 32k, white ink head 36, clear ink head 38, modeling material head 34, and support material head 40, and also controls the operations of the ultraviolet light sources 44 and the flattening roller unit 46.

The deformation restrainer controller 28 controls the operation to form the deformation restrainer 7. In response to receipt of three-dimensional data indicating the shape of the three-dimensional object 5 to be obtained inputted, for example, from the input unit 21, the deformation restrainer controller 28 determines based on the inputted three-dimensional data whether a predetermined target portion is formable with the modeling material in the object-shaping operation. The target portion may include any portion deformable under stress, such as a flat portion, a linear portion, or a bar-shaped portion. The target portion is not necessarily limited to any part of the completed three-dimensional object 5 but includes any portion temporarily formed during the object-shaping operation. When it is determined that the target portion is formable, the deformation restrainer controller 28 forms the deformation restrainer 7 in addition to the three-dimensional object 5. The deformation restrainer controller 28 decides and sets a position and shape of the deformation restrainer 7 depending on a shape of the target portion to be formed. The deformation restrainer 7 may be provided irrespective of any shape of the target portion, for example, whether the target portion has an inclined, curved, or spherical surface, or has a linear or curved part. In case the target portion has any shape that may be subject to a greater deformation-causing stress, for example, large, thin, and flat target shape, the deformation restrainer controller 28 may connect the deformation restrainer 7 to a lower end side of the target portion in a layer-stacking direction. This may ensure that possible deformation of the target portion is prevented in an early stage of the object shaping step. The shape of the deformation restrainer 7 may be selected from data of a plurality of finite shapes previously stored in the storage 24 described later, or may be decided and set based on a signal externally inputted by an operator. The shape of the deformation restrainer 7 may be selected from various shapes including circular, polygonal, curved, and bent shapes. The deformation restrainer controller 28 transmits data set for the position and shape of the deformation restrainer 7 to the head controller 27. The deformation restrainer controller 28 may be installed in an external apparatus or may be prepared and set when shape-related data is generated.

In the storage 24 are stored programs and data associated with the object-shaping operation of the three-dimensional object shaping apparatus 10. The storage 24 has a shape-related data storage 29. The shape-related data storage 29 is used to store shape-related data of the deformation restrainer 7.

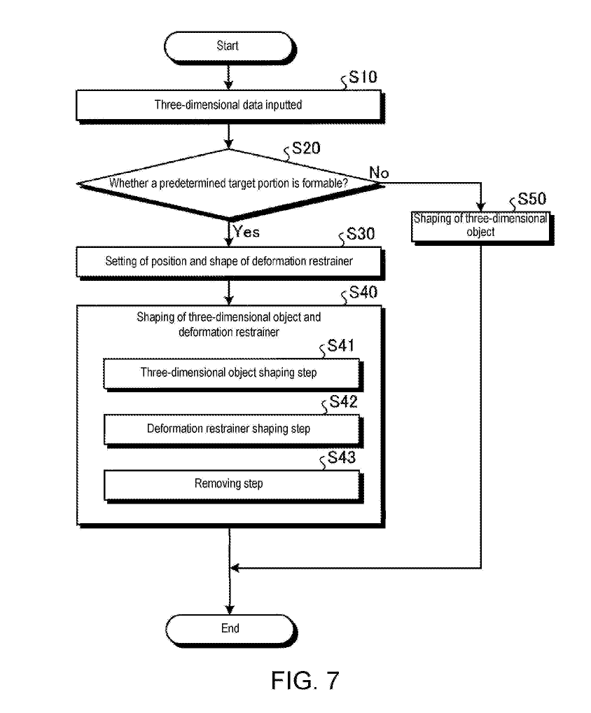

Next, the operation of the three-dimensional object shaping apparatus 10 is hereinafter described. FIG. 7 is a flow chart of the operation carried out by the three-dimensional object shaping apparatus 10. FIGS. 8 to 10 are drawings that each illustrate a stage in the operation carried out by the three-dimensional object shaping apparatus 10. In Step S10, three-dimensional data of the three-dimensional object 5 from an external apparatus is inputted to the controller 20, as illustrated in FIG. 7. Based on the inputted three-dimensional data of the three-dimensional object 5, the deformation restrainer controller 28 determines whether a predetermined target portion is formable with the modeling material in the object-shaping operation (Step S20).

When it is determined that the target portion is formable (Yes in Step S20), the deformation restrainer controller 28 forms the deformation restrainer 7 in addition to the three-dimensional object 5. The deformation restrainer controller 28 decides and sets the position and shape of the deformation restrainer 7 depending on the shape of the target portion (Step S30). The deformation restrainer controller 28 transmits data set for the position and shape of the deformation restrainer 7 to the head controller 27.

The head controller 27 that received the set data from the deformation restrainer controller 28 controls the operations of the heads, ultraviolet light sources 44, and flattening roller unit 46 based on the received data, and forms the three-dimensional object 5 and the deformation restrainer 7 (Step S40). In Step S40, the controller 20 prompts a three-dimensional object shaping step S41 to be carried out, in which the modeling material constituting the table 50 (three-dimensional object 5) and the support material that supports the three-dimensional object are ejected in layers to the working plane 18.

In the three-dimensional object shaping step S41, based on the three-dimensional data received from an external apparatus, the drive controller 26 drives the main scan driver 14 and the object-shaping table 16 to operate, and the head controller 27 controls the operation to eject inks from the ejection unit 12. As a result, a modeling material Q1 and a support material Q2 ejected from the ejection unit 12 are layered in a shape as indicated by the three-dimensional data on the working plane 18 of the object-shaping table 16, as illustrated in FIG. 8.

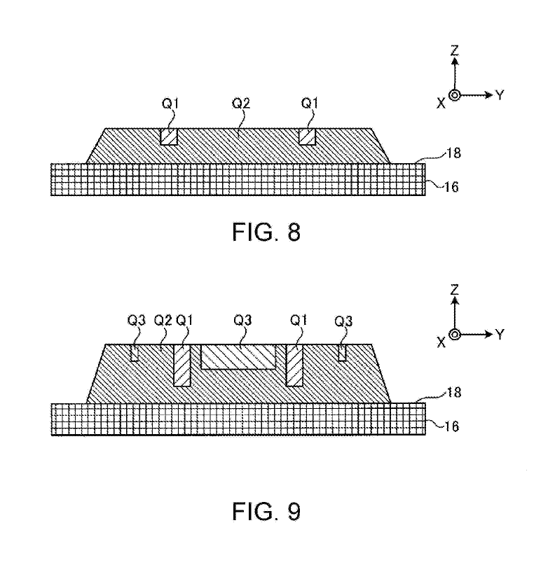

The controller 20 further prompts a deformation restrainer shaping step S42 to be carried out, in which the deformation restrainer 7 is formed. In the deformation restrainer shaping step S42, based on the set data from the deformation restrainer controller 28, the drive controller 26 drives the main scan driver 14 and the object-shaping table 16 to operate, and the head controller 27 controls the operation to eject inks from the ejection unit 12. As a result, a deformation restrainer material Q3 constituting the deformation restrainer 7 is ejected to and layered at a position in a shape as indicated by design data, as illustrated in FIG. 9. In this embodiment, the deformation restrainer material Q3 and the modeling material Q1 are the same material. Thus, Step S40 includes the deformation restrainer shaping step S42 of forming the deformation restrainer 7 and the three-dimensional object shaping step S41 of forming the three-dimensional object. When the modeling material Q1 and the support material Q2 are ejected from the ejection unit 12 in a main scan, the deformation restrainer material Q3 is ejected as well in the same main scan.

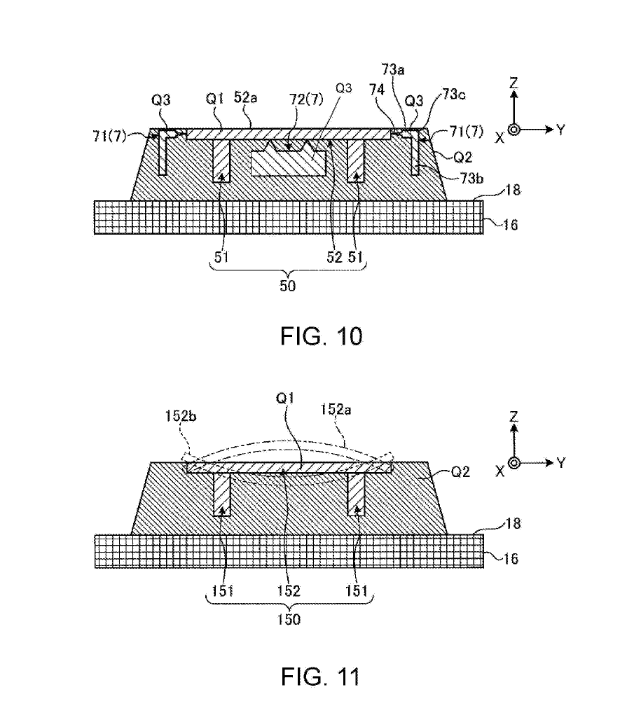

As a result of the three-dimensional object shaping step S41 and the deformation restrainer shaping step S42, the three-dimensional object 5 (the table 50 having the legs 51 and the top plate 52) is formed on the working plane 18 of the object-shaping table 16, as illustrated in FIG. 10. The table 50 is supported by the support material Q2. In FIG. 10, the top plate 52 is supported by the support material Q2 and has its upper surface 52a left exposed. In this embodiment, the portion formed of the modeling material Q1 has a higher degree of hardness than the support 6 formed of the support material Q2. The top plate 52, which is the target portion, is harder than the support 6 made of the layers of the support material Q2.

Within the support material Q2, the deformation restrainer 7 is formed that includes the side restrainers 71 connected to the side surfaces 52b of the top plate 52 and the bottom restrainer 72 connected to the bottom surface 52c of the top plate 52. The side restrainers 71 are situated on lateral sides of the top plate 52 of the table 50. In the deformation restrainer shaping step S42, the deformation restrainer 7 is formed on the support material Q2 on the working plane 18. The deformation restrainer 7 is formed away from the working plane 18, i.e., without any contact with the working plane 18, as illustrated in FIG. 10. The deformation restrainer 7 is formed in contact in at least a part thereof with the support material Q2. The side restrainers 71 of the deformation restrainer 7 illustrated in FIG. 10 are each in contact with the support material Q2 in the whole surface of the base 73 (first piece 73a, second piece 73b, bending part 73c). The bottom restrainer 72 is in contact with the support material Q2 in the whole surface of the base 75. When the side restrainers 71 and the bottom restrainer 72 are subject to stress causing deformation in the X direction, Y direction, Z direction, θX direction, θY direction, and/or θZ direction, the support 6 in contact with the side restrainers 71 and the bottom restrainer 72 immobilizes these restrainers, acting against such stress-driven deformation. The cross section of the connector 74 may be suitably adjusted depending on the magnitude of stress acting on the top plate 52 which is the target portion.

When deformation of the top plate 52 (target portion) formed of the modeling material Q1, is possibly occurring, the side restrainers 71 and the bottom restrainer 72 are subject to stress causing the deformation. The side restrainers 71 and the bottom restrainer 72, under the stress, are subject to at least one of a frictional force or a pressure from the support 6. This frictional force and/or pressure is a force that acts against the stress-driven deformation.

In this embodiment, the deformation restrainer 7 is formed of the modeling material Q1. A portion formed of the modeling material Q1 has a higher degree of hardness than the support 6 formed of the support material Q2. The deformation restrainer 7 is, therefore, harder than the support 6 which is the layered structure of the support material Q2. Thus, unwanted penetration may be prevented when deformation of the top plate 52 (target portion) occurs.

Step S40 includes a removing step S43 of removing the deformation restrainer 7 connected to the top plate 52 after the table 50 (three-dimensional object 5) formed of the modeling material Q1 is obtained and the support material Q2 is removed. In the removing step S43, the deformation restrainer 7 may be easily removed by cutting or bending its part connected to the top plate 52 (for example, connectors 74). A nipper or a cutter may be used as a cutting means. Part of the top plate 52 from which the deformation restrainer 7 has been removed is then subjected to a surface treatment such as polishing. As a result, the table 50 is obtained as a final product.

When the deformation restrainer controller 28 determines in Step S20 that the flat, linear, or bar-shaped target portion is not formable (No in Step S20), the head controller 27 prompts the object-shaping operation to be carried out without the deformation restrainer 7 being formed (Step S50). In Step S50, the head controller 27 controls the operation as in the three-dimensional object shaping step S41 of Step S40.

Subsequent to Step S40 or Step S50, the controller 20 stops the operations of the respective structural elements to finish the object-shaping operation when an operation-end signal outputted from a program or inputted from an external apparatus is detected.

FIG. 11 is a drawing of an exemplified deformation of a table 150 according to a comparative example. FIG. 11 illustrates the table 150 currently formed in an equal shape and dimension to the table 50, in which no deformation restrainer 7 is formed. In the table 150 currently formed, the modeling material Q1 of a top plate 152 constitutes a flat shape on the support material Q2, as illustrated in FIG. 11. In this stage, the top plate 152 may possibly detach from the support material Q2 under stress and deform toward the ejection unit 12. Specifically, the top plate 152 may possibly deform as illustrated with 152a or 152b in FIG. 11. A deformation 152a indicates that a portion at the center of the top plate 152 is deformed away from the support material Q2. A deformation 152b indicates that end parts of the top plate 152 are deformed away from the support material Q2. Such deformation is not necessarily limited to the top plate 152 formed on the support material Q2. The top plate 152 directly formed on the working plane 18 may similarly deform toward the ejection unit 12. Such deformation of the top plate 152 toward the ejection unit 12 may cause the three-dimensional object 5 to degrade in quality or cause the three-dimensional object 5 to be poorly shaped in case any deformed part contacts the ejection unit 12.

To address such an issue, the three-dimensional object shaping method according to this embodiment is a method for shaping the three-dimensional object 5 on the working plane 18, including: the three-dimensional object shaping step S41 of stacking the modeling material Q1 and the support material Q2 in layers on the working plane 18, the modeling material Q1 constituting the three-dimensional object 5, the support material Q2 serving to support the modeling material Q1; and the deformation restrainer shaping step S42 of forming the deformation restrainer 7 away from the working plane 18 and in contact in at least a part thereof with the support material Q2, the deformation restrainer 7 being a portion distinct from the top plate 52 (target portion) formed of the modeling material Q1 in the three-dimensional object shaping step S41 and serving to generate a force that acts against stress causing the top plate 52 to deform.

According to this embodiment, the deformation restrainer 7 may serve to generate a force that acts against such stress-driven deformation, if any, of the top plate 52 which is the target portion. This may suppress the risk of the top plate 52 being deformed. Because the deformation restrainer 7 at least partly stays in contact with the support material Q2, the contact with the support material Q2 may ensure that a force is generated against possible deformation of the top plate 52. Further, the deformation restrainer 7 formed in contact with the three-dimensional object 5 may suppress the risk of possible deformation of the top plate 52 (target portion) regardless of any shape of the three-dimensional object 5. In the three-dimensional object shaping method for shaping the three-dimensional object 5 on the working plane 18, the three-dimensional object shaping step S41 may be a step of shaping the three-dimensional object 5 by stacking a powdery material in layers on the working plane 18 and repeatedly irradiating the layers with laser light appropriate for shape-related data. In this instance, the deformation restrainer shaping step S42 may be a step of forming, simultaneously with the formation of the three-dimensional object 5, the deformation restrainer 7 in contact in at least a part thereof with the three-dimensional object 5, the deformation restrainer 7 being a portion distinct from the top plate 52 (target portion) of the three-dimensional object 5 formed in the three-dimensional object shaping step and serving to generate a force that acts against stress causing the top plate 52 to deform. The three-dimensional object shaping step S41 may be a step of forming the three-dimensional object 5 by stacking a powdery material in layers on the working plane 18 and ejecting a binder material appropriate for the shape-related data to the powdery material. In this instance, the deformation restrainer shaping step S42 may be a step of forming, simultaneously with the formation of the three-dimensional object 5, the deformation restrainer 7 in contact in at least a part thereof with the three-dimensional object 5, the deformation restrainer 7 being a portion distinct from the top plate 52 (target portion) of the three-dimensional object 5 formed in the three-dimensional object shaping step and serving to generate a force that acts against stress causing the top plate 52 to deform.

In the three-dimensional object shaping method according to this embodiment, the deformation restrainer shaping step S42 may form the connectors 74 that allows the deformation restrainer 7 to connect in at least a part thereof to the top plate 52 which is the target portion. This may allow the deformation restrainer 7 to receive, through the connector 74, stress possibly causing the top plate 52 to deform and thus further ensures that a force is generated against such deformation-causing stress.

In the three-dimensional object shaping method according to this embodiment, the deformation restrainer shaping step S42 may form the bases 73, 75 of the deformation restrainer 7 on the opposite side of the top plate 52 across the connectors 74, so that the connectors 74 are tapered and thinner toward the top plate 52. According to this configuration, the connector 74 has a part progressively thinner toward the top plate 52. After the object is completed, therefore, the thinned part may facilitate removal of the deformation restrainer that is no longer necessary.

The three-dimensional object shaping method according to this embodiment may further include the removing step S43 of removing the deformation restrainer 7 connected to the top plate 52 from the three-dimensional object 5 after the object 5 formed of the modeling material Q1 is completed and the support material Q2 is removed. According to this configuration, the three-dimensional object 5 may be readily obtained by removing the deformation restrainer 7 after the support material Q2 is removed from the completed three-dimensional object 5.

In the three-dimensional object shaping method according to this embodiment, the deformation restrainer shaping step S42 may form the deformation restrainer 7 in a shape having the second piece 73b formed along a direction intersecting with the working plane 18. According to this configuration, the deformation restrainer 7 having the second piece 73b formed along a direction intersecting with the working plane 18 may be prevented from extending along the working plane 18. As a result, the support material Q2 used may be economized.

In the three-dimensional object shaping method according to this embodiment, the deformation restrainer shaping step S42 may form the deformation restrainer 7 in a shape having a flat portion parallel to the working plane 18. According to this configuration, the flat portion may enhance the contact with the support material Q2 and thereby ensure that a force is generated against possible deformation of the top plate 52.

In the three-dimensional object shaping method according to this embodiment, the deformation restrainer shaping step S42 may form at least two deformation restrainers 7 in a direction intersecting with the working plane 18. One of the two deformation restrainers 7 closer to the working plane 18 may have a shape with a flat portion parallel to the working plane 18, while the other one of the two deformation restrainers 7 farther from the working plane 18 may have a shape with a portion formed along a direction intersecting with the working plane 18. By thus having at least two deformation restrainers 7, the deformation restrainers 7 may be prevented from extending along the working plane 18, and a force may be surely generated against possible deformation of the top plate 52.

In the three-dimensional object shaping method according to this embodiment, the deformation restrainer shaping step S42 may form the deformation restrainer 7 using the modeling material Q1. Using the modeling material Q1 to form the deformation restrainer 7 may save additional labor of preparing a dedicated material for the deformation restrainer 7.

In the three-dimensional object shaping method according to this embodiment, the deformation restrainer 7 may have a higher degree of hardness than layers of the support material Q2. According to this configuration, unwanted penetration may be prevented when deformation of the deformation restrainer 7 occurs.

In the three-dimensional object shaping method according to this embodiment, the top plate 52 may have a higher degree of hardness than layers of the support material Q2. While the top plate 52, if deformed, is possibly detached from the support material, the top plate 52 harder than layers of the support material Q2 may be unlikely to detach from the support material Q2.

The three-dimensional object shaping apparatus 100 according to this embodiment is an apparatus that forms the three-dimensional object 5 on the working plane 18, including: the ejection unit 12 that stacks the modeling material Q1, the support material Q2, and the deformation restrainer material Q3 in layers on the working plane 18, the modeling material Q1 constituting the three-dimensional object 5, the support material Q2 serving to support the modeling material Q1, the deformation restrainer material Q3 constituting the deformation restrainer 7 being a portion distinct from top plate 52 (target portion) formed of the modeling material Q1 and serving to generate a force that acts against stress causing the top plate 52 to deform; and the controller 20 that prompts the ejection unit 12 to form, apart from the three-dimensional object 5, the deformation restrainer 7 away from the working plane 18 and in contact in at least a part thereof with the support material Q2 at the time of the top plate 52 (target portion) being formed.

According to this configuration, a force that acts against stress causing the top plate 52 (target portion) to deform may be effectively generated. The risk of the top plate 52 being deformed may be accordingly reduced, and the object-shaping operation may be smoothly performed. The three-dimensional object shaping apparatus 100 may be equipped with, in place of the ejection unit 12, an object-shaping unit that stacks a powdery material in layers on the working plane 18 and irradiates the layers with laser light appropriate for shape-related data so as to form the three-dimensional object 5 and the deformation restrainer 7, the deformation restrainer 7 being a portion distinct from the top plate 52 (target portion) of the three-dimensional object 5 and serving to generate a force that acts against stress causing the top plate 52 to deform. The three-dimensional object shaping apparatus 100 may be equipped with, in place of the ejection unit 12, an object-shaping unit that stacks a powdery material in layers on the working plane 18 and ejects a binder material appropriate for shape-related data to the powdery material so as to form the three-dimensional object 5 and the deformation restrainer 7 distinct from the top plate 52 (target portion) of the three-dimensional object 5 and serving to generate a force that acts against stress causing the top plate 52 to deform. When the top plate 52 is formed by the apparatus thus configured, the controller 20 may prompt the object-shaping unit to form, simultaneously with the formation of the three-dimensional object, the deformation restrainer 7 in contact in at least a part thereof with the three-dimensional object 5.

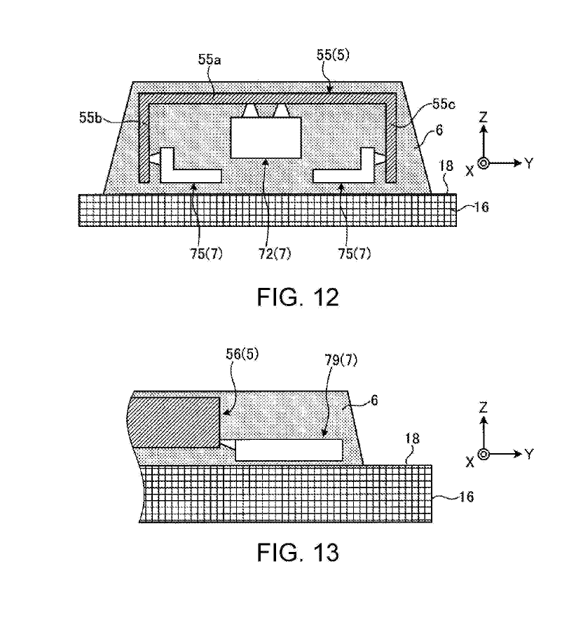

The technical scope of this disclosure includes but is not necessarily limited to the embodiment described thus far. Any modifications within the scope and spirit of this disclosure may be acceptable. For example, the target portion of the three-dimensional object described in the embodiment is the flat top plate 52 of the table 50, however, is not necessarily limited thereto. FIG. 12 is a drawing of a modified example of the three-dimensional object 5 formed on the working plane 18 and the deformation restrainer 7. In the example illustrated in FIG. 12, the three-dimensional object 5 is a C-shaped member 55 having a bottom plate 55a and side plates 55b and 55c.

In the C-shaped member 55, the bottom restrainer 72 (deformation restrainer 7) is connected to the bottom plate 55a of the C-shaped member 55. The side restrainers 75 (deformation restrainer 7) are connected to the side plates 55b and 55c. The side restrainers 75 are set in a region between the side plates 55b and 55c, i.e., in the hollowed inside of the C-shaped member 55. The support material layered on an outside of the side plates 55b and 55c may be reduced as compared with having the side restrainers 75 connected to the side plates 55b and 55c from an outside of the hollowed inside of the C-shaped member 55. When the C-shaped member 55 is positioned without its hollowed inside been seen, removal of the deformation restrainer 7 may be unnecessary, in which case the removing step may be skipped.

FIG. 13 is a drawing of a modified example of the three-dimensional object 5 formed on the working plane 18 and the deformation restrainer 7. In the example illustrated in FIG. 13, the three-dimensional object 5 is a block-shaped member 56. When the block-shaped member 56 is formed, a modeling material prepared for this member is stacked in layers vertically upward on the support material. During the formation of the block-shaped member, the modeling material layered in a flat shape on the support material may possibly deform and detach from the support material. In the example of FIG. 13, when a three-dimensional object desirably obtained has no flat portion in its final shape, the deformation restrainer 7 is connected to the three-dimensional object 5 insofar as such a flat portion is formed on the support material during the operation to form this object. While the side restrainers 79 are connected, as the deformation restrainer 7, to the side surfaces of the block-shaped member 56 in FIG. 13, a bottom restrainer may instead be connected to a bottom surface of the block-shaped member 56.

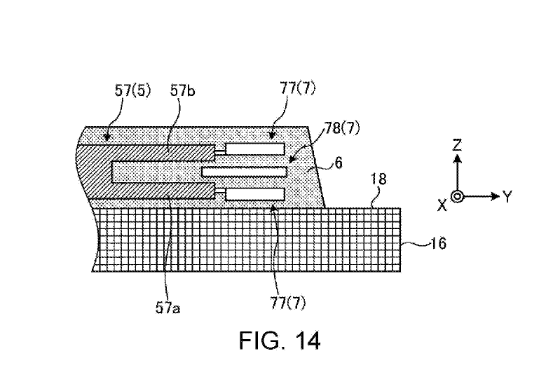

FIG. 14 is a drawing of a modified example of the three-dimensional object 5 formed on the working plane 18 and the deformation restrainer 7. In the example illustrated in FIG. 14, the three-dimensional object 5 is a member 57 having plate-shaped portions 57a and 57b that are spaced apart in the layer-stacking direction. In the member 57 thus shaped, the modeling material is layered in a flat shape on the support material at different times. At the time of the plate-shaped portions 57a and 57b being formed, therefore, the side restrainers 77 (deformation restrainer 7) are connected to side surfaces of the plate-shaped portions 57a and 57b.

After the plate-shaped portion 57a is formed, a floating restrainer 78 may be formed as the deformation restrainer 7 between and away from the plate-shaped portions 57a and 57b. In this structural option, a force that acts against deformation-causing stress may be acted upon the plate-shaped portion 57a when one end of the plate-shaped portion 57a on +Y side deforms toward +Z side. Likewise, a force that acts against deformation-causing stress may be acted upon the plate-shaped portion 57b when one end of the plate-shaped portion 57b on +Y side deforms toward −Z side. Thus, the deformation restrainer 7 is not necessarily connected to the target portion per se insofar as the target portion formed of the modeling material can be subject to a force that acts against deformation-causing stress. By not having the deformation restrainer 7 connected to the target portion, removal of the deformation restrainer 7 from the three-dimensional object 5 becomes unnecessary after the support 6 is removed.

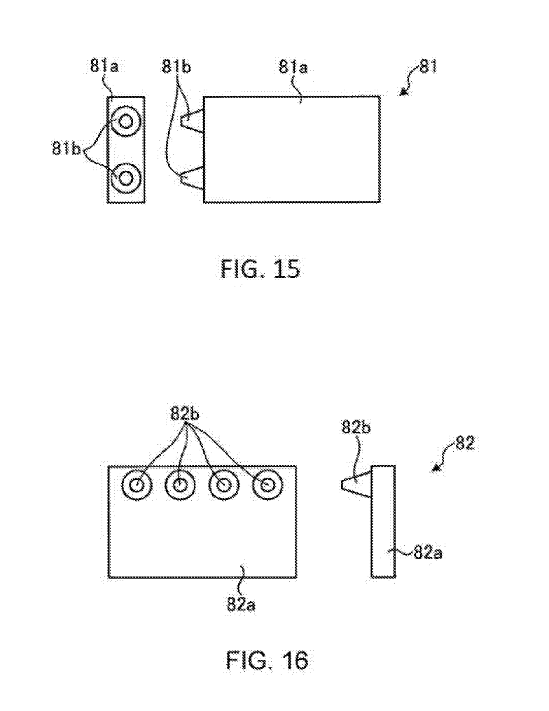

FIGS. 15 to 18 are drawings of other examples of the deformation restrainer 7. Suitable one of these examples may be selected depending on the shape of the three-dimensional object 5, direction of deformation, degree of deformation, and position at which and direction in which the deformation restrainer 7 is attachable. A deformation restrainer 81 illustrated in FIG. 15 includes a base 81a having a flat rectangular shape and connectors 81b having a truncated conical shape. The two connectors 81b are arranged next to each other on side surfaces of the base 81a, however, the connectors 81b may be arranged otherwise.

A deformation restrainer 82 illustrated in FIG. 16 includes a base 82a having a flat rectangular shape and connectors 82b having a truncated conical shape. The four connectors 82b are arranged next to one another on a surface of the base 82a, however, the connectors 82b may be arranged otherwise.

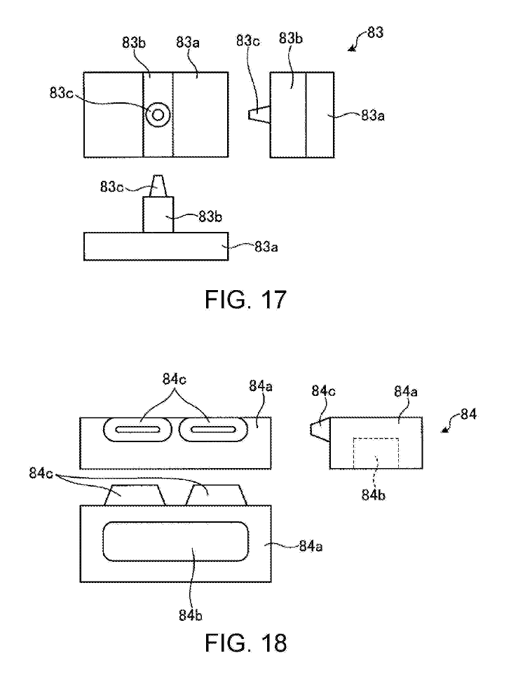

A deformation restrainer 83 illustrated in FIG. 17 has a first base 83a having a flat rectangular shape, a protrusion 83b protruding from the first base 83a, and a connector 83c. This deformation restrainer may be suitable for a narrow, thin, or curved structure or object. The protrusion 83b is disposed at a position at the center of the first base 83a in its longitudinal direction. The connector 83c is disposed at a protruding edge of the protrusion 83b. Positions, shapes or the like of the protrusion 83b and the connector 83c, however, may be decided otherwise.

A deformation restrainer 84 illustrated in FIG. 18 has a base 84a with a dented part 84b, and connectors 84c. This deformation restrainer is suitable for deformation caused by greater stress. The dented part 84b in the base 84a and the connectors 84c linearly extending may allow for a greater area of contact with the support material and a greater area in total of the connectors 84c. This may ensure that a greater force is acted against stress causing the target portion to deform.

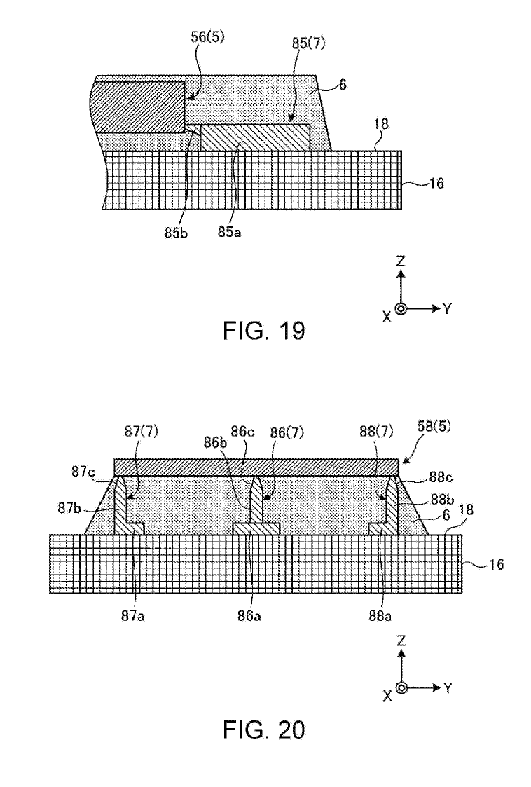

FIG. 19 is a drawing that illustrates an example of the deformation restrainer 7. In the example illustrated in FIG. 19, a deformation restrainer 85 has a base 85a and a connector 85b. The base 85a is formed so that its whole lower surface is allowed to contact the working plane 18. The lower surface of the base 85a may at least partly contact the working plane 18, instead of the whole lower surface making contact with the working plane 18. The base 85a can be formed by directly ejecting ink to the working plane 18. The connector 85b may be extending from the base 85a toward the block-shaped member 56, and an edge of the connector 85b is connected to the three-dimensional object 5. Thus, the base 85a of the deformation restrainer 85 is in contact with the working plane 18. A force that acts against any deformation-causing stress, therefore, may be more stably and reliably generated. While the block-shaped member 56 is formed as the three-dimensional object 5 in the example illustrated in FIG. 19, the description given so far may be applicable to the three-dimensional object 5 having other shapes.

FIG. 20 is a drawing that illustrates an example of the deformation restrainer 7. In the example illustrated in FIG. 20, the deformation restrainer 7 includes deformation restrainers 86, 87, and 88 arranged below a flat member 58. The deformation restrainer 86 is set at a position below the center of the flat member 58. The deformation restrainer 87 is set at a position below one end of the flat member 58 (left end in FIG. 20). The deformation restrainer 88 is set at a position below the other end of the flat member 58 (right end in FIG. 20).

The deformation restrainer 86 has a base 86a, a protrusion 86b, and a connector 86c. The base 86a is formed so that its whole lower surface is allowed to contact the working plane 18. The protrusion 86b is extending upward toward the flat member 58 from the center of the base 86a. The connector 86c is connected to a lower surface of the flat member 58. The deformation restrainer 87 has a base 87a, a protrusion 87b, and a connector 87c. The base 87a is formed so that its whole lower surface is allowed to contact the working plane 18. The protrusion 87b is extending upward toward the flat member 58 from one end (left end in FIG. 20) of the base 87a. The connector 87c is connected to the lower surface of the flat member 58. The deformation restrainer 88 has a base 88a, a protrusion 88b, and a connector 88c. The base 88a is formed so that its whole lower surface is allowed to contact the working plane 18. The protrusion 88b is extending upward toward the flat member 58 from the other end (right end in FIG. 20) of the base 88a. The connector 88c is connected to the lower surface of the flat member 58.

Thus, the bases 86a, 87a, and 88a of the deformation restrainers 86, 87, and 88 are in contact with the working plane 18. A force that acts against any deformation-causing stress, therefore, may be even more stably and reliably generated. The lower surfaces of the bases 86a, 87a, and 88a may at least partly contact the working plane 18, instead of the whole lower surfaces making contact with the working plane 18. The bases 86a, 87a, and 88a can be formed by directly ejecting ink to the working plane 18. The shapes of the deformation restrainers 85, 86, 87, and 88 may be decided and set depending on the shape of the three-dimensional object 5, or may be selected from pre-stored shapes.

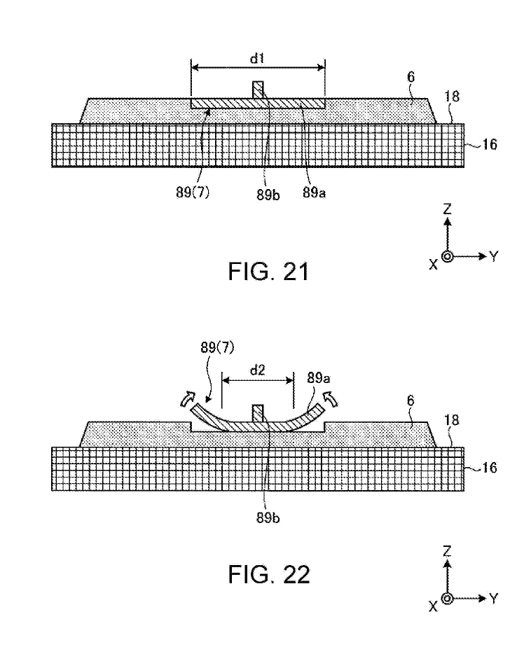

FIGS. 21 to 23 are drawings of examples of the three-dimensional object shaping method. As illustrated in FIG. 21, the support 6 is formed on the working plane 18, and a base 89a and a connector 89b of a deformation restrainer 89 are formed on the support 6. The base 89a may be formed so that its lateral direction in FIG. 21 is coincident with the longitudinal direction. The base 89a has a longitudinal dimension d1 that can be set to a suitable value in accordance with dimensions of the three-dimensional object.

Longitudinal both ends of the base 89a may possibly warp and detach from the support 6 depending on the longitudinal dimension d1, as illustrated in FIG. 22, while a portion of the base 89a including its longitudinal center part is in contact with the support 6. A dimension of the portion of the base 89a in contact with the support 6 may be set to d2 smaller than d1. While FIG. 22 illustrates possible warp of the longitudinal both ends of the base 89a, the description given so far and below may be applicable to warp of a portion at the center of the base 89a in the longitudinal direction.

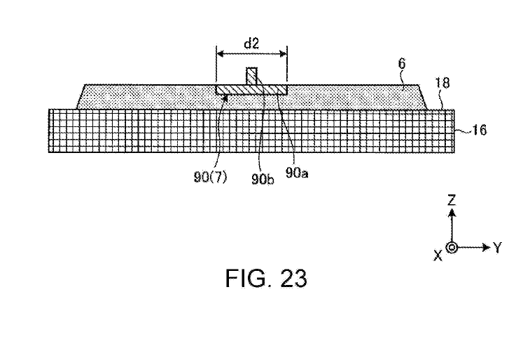

As described earlier, ends of the base 89a in the deformation restrainer 89 formed on the support 6 may detach and warp away from the support material 6. To avoid that, a deformation restrainer 90 is formed on the support 6, as illustrated in FIG. 23. The deformation restrainer 90 has a base 90a smaller than the dimension d1 in a planar direction in which ends of the base 89a are detachable (longitudinal direction in this example). In this instance, d2 may be a dimension of the deformation restrainer 90 corresponding to the longitudinal direction of the deformation restrainer 89. The dimension is not necessarily limited to d2 and may be set to any value that allows to prevent ends of the base 90a from warping.

In case ends of the base 89a formed on the support 6 warp away from the support 6, the base 90a shorter in an end-warping direction may be formed instead. The ends of the base 90a longitudinally shorter may be unlikely to warp away from the support 6.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for shaping a three-dimensional object on a working plane, the method comprising:
a three-dimensional object shaping step of stacking layers of a modeling material and layers of a support material on the working plane, the modeling material constituting the three-dimensional object, the support material serving to support the modeling material; and
a deformation restrainer shaping step of forming a deformation restrainer away from the working plane and in contact in at least a part of the deformation restrainer with the support material, the deformation restrainer being a portion distinct from a target portion formed of the modeling material in the three-dimensional object shaping step and serving to generate a force that acts against stress causing the target portion to deform.

2. The method according to claim 1, wherein the deformation restrainer shaping step forms a connector that allows the deformation restrainer to connect in at least a thinned part of the deformation restrainer to the target portion.

3. The method according to claim 2, wherein the deformation restrainer shaping step forms a base of the deformation restrainer on a side opposite to the target portion across the connector, so that the connector is tapered and thinner toward the target portion.

4. The method according to claim 3, wherein the deformation restrainer shaping step forms the base so as to have a shorter dimension in a planar direction in which ends of the base formed on the support material to possibly detach and warp away from the support material.

5. The method according to claim 2, further comprising a deformation restrainer removing step of removing the deformation restrainer connected to the target portion from the three-dimensional object after the three-dimensional object is formed of the modeling material and the support material is removed.

6. The method according to claim 1, wherein the deformation restrainer shaping step forms the deformation restrainer in a shape having a portion formed along a direction intersecting with the working plane.

7. The method according to claim 1, wherein the deformation restrainer shaping step forms the deformation restrainer in a shape having a flat portion formed parallel to the working plane.

8. The method according to claim 1, wherein the deformation restrainer shaping step forms at least two deformation restrainers in a direction intersecting with the working plane, and
one of the two deformation restrainers closer to the working plane has a shape with a flat portion parallel to the working plane, and the other one of the two deformation restrainers farther from the working plane has a shape with a portion bending toward the working plane.

9. The method according to claim 1, wherein the deformation restrainer shaping step forms the deformation restrainer using the modeling material.

10. The method according to claim 1, wherein the deformation restrainer has a higher degree of hardness than the layers of the support material.

11. The method according to claim 1, wherein the target portion has a higher degree of hardness than the layers of the support material.

12. A method for shaping a three-dimensional object on a working plane, the method comprising:
a three-dimensional object shaping step of stacking layers of a powdery material on the working plane and repeatedly irradiating the layers with laser light appropriate for shape-related data to form the three-dimensional object; and
a deformation restrainer shaping step of forming, simultaneously with the three-dimensional object shaping step, a deformation restrainer in contact in at least a part of the deformation restrainer with the three-dimensional object, the deformation restrainer being a portion distinct from a target portion formed in the three-dimensional object shaping step and serving to generate a force that acts against stress causing the target portion to deform.

13. A method for shaping a three-dimensional object on a working plane, the method comprising:
a three-dimensional object shaping step of stacking layers of a powdery material on the working plane and ejecting a binder material appropriate for shape-related data to the powdery material to form the three-dimensional object; and
a deformation restrainer shaping step of forming, simultaneously with the three-dimensional object shaping step, a deformation restrainer in contact in at least a part of the deformation restrainer with the three-dimensional object, the deformation restrainer being a portion distinct from a target portion formed in the three-dimensional object shaping step and serving to generate a force that acts against stress causing the target portion to deform.

14. A method for shaping a three-dimensional object on a working plane, the method comprising:
a three-dimensional object shaping step of stacking layers of a modeling material and layers of a support material on the working plane, the modeling material constituting the three-dimensional object, the support material serving to support the modeling material; and
a deformation restrainer shaping step of forming a deformation restrainer in contact in at least a part of the deformation restrainer with the working plane and in contact in at least a part of the deformation restrainer with the support material, the deformation restrainer being a portion distinct from a target portion formed of the modeling material and serving to generate a force that acts against stress causing the target portion to deform.

15. An apparatus configured to shape a three-dimensional object on a working plane, the apparatus comprising:
an inkjet ejection unit that ejects a modeling material, a support material, and a deformation restrainer material to the working plane, the modeling material constituting the three-dimensional object, the support material serving to support the modeling material, the deformation restrainer material forming a deformation restrainer, the deformation restrainer being a portion distinct from a target portion formed of the modeling material and serving to generate a force that acts against stress causing the target portion to deform; and
a controller that prompts the inkjet ejection unit to form the deformation restrainer away from the working plane and in contact in at least a part of the deformation restrainer with the support material at a time of the target portion being formed.

16. An apparatus configured to shape a three-dimensional object on a working plane, the apparatus comprising:
an object shaping unit that stacks layers of a powdery material on the working plane and repeatedly irradiating the layers with laser light appropriate for shape-related data to form the three-dimensional object and a deformation restrainer, the deformation restrainer being a portion distinct from a target portion of the three-dimensional object and serving to generate a force that acts against stress causing the target portion to deform; and
a controller that prompts the object-shaping unit to form, simultaneously with the formation of the three-dimensional object, the deformation restrainer in contact in at least a part of the deformation restrainer with the three-dimensional object at a time of the target portion being formed.

17. An apparatus configured to shape a three-dimensional object on a working plane, the apparatus comprising:
an object shaping unit that stacks layers of a powdery material on the working plane and ejecting a binder appropriate for shape-related data to the powdery material to form the three-dimensional object and a deformation restrainer, the deformation restrainer being a portion distinct from a target portion of the three-dimensional object and serving to generate a force that acts against stress causing the target portion to deform; and
a controller that prompts the object-shaping unit to form, simultaneously with the formation of the three-dimensional object, the deformation restrainer in contact in at least a part of the deformation restrainer with the three-dimensional object at a time of the target portion being formed.
